(19) United States
(12) Patent Application Publication
(10) Pub. No.: US 2018/0249172 A1
(43) Pub. Date: Aug. 30, 2018

(54) METHOD AND APPARATUS OF MOTION COMPENSATION FOR VIDEO CODING BASED ON BI PREDICTION OPTICAL FLOW TECHNIQUES

(71) Applicant: MEDIATEK INC., Hsin-Chu (TW)

(72) Inventors: Ching-Yeh CHEN, Taipei City (TW); Tzu-Der CHUANG, Zhubei City, Hsinchu County (TW); Yi-Wen CHEN, Taichung City (TW); Yu-Chen SUN, Keelung City (TW); Yu-Wen HUANG, Taipei City (TW)

(21) Appl. No.: 15/754,683

(22) PCT Filed: Aug. 31, 2016
(86) PCT No.: PCT/CN2016/097596

§ 371 Date: Feb. 23, 2018

Related U.S. Application Data
(60) Provisional application No. 62/213,249, filed on Sep. 2, 2015.

(51) Int. Cl. H04N 19/513; H04N 19/182; H04N 19/176

(52) U.S. Cl. CPC H04N 19/513; H04N 19/176; H04N 19/182

(57) ABSTRACT

A method and apparatus of motion compensation using the bi-directional optical flow (BIO) techniques are disclosed. According to one method, the use of BIO is extended to general bi-prediction motion compensation by including the case that two reference pictures correspond to two previously coded pictures. According to another method, the use of BIO is adaptively applied depending on the linearity of the two motion vectors associated with the two reference blocks or depending on block size of the current block. According to yet another method, the refined motion vectors by compensating the original motion vectors with the respective x-offset values and y-offset values are stored in a motion-vector buffer for motion vector prediction of one or more following blocks.

### CROSS REFERENCE TO RELATED APPLICATIONS

The present invention claims priority to U.S. Provisional Patent Application, Ser. No. 62/213,249, filed on Sep. 2, 2015. The U.S. Provisional Patent Application is hereby incorporated by reference in its entirety.

### TECHNICAL FIELD

The present invention relates to motion compensation for video coding using bi-directional optical flow (BIO) techniques. In particular, the present invention relates to extending the BIO to more general cases, or applying BIO adaptively to improve performance or reducing complexity.

### BACKGROUND

Bi-directional optical flow (BIO) is motion estimation/compensation technique disclosed in JCTVC-C204 (E. Alshina, et al., Bi-directional optical flow, Joint Collaborative Team on Video Coding (JCT-VC) of ITU-T SG 16 WP 3 and ISO/IEC JTC 1/SC 29/WG 11, 3rd Meeting: Guangzhou, CN, 7-15 Oct. 2010, Document: JCTVC-C204) and VCEG-AZ05 (E. Alshina, et al., Known tools performance investigation for next generation video coding, ITU-T SG 16 Question 6, Video Coding Experts Group (VCEG), 52^{nd} Meeting: 19-26 Jun. 2015, Warsaw, Poland, Document: VCEG-AZ05). BIO derived the sample-level motion refinement based on the assumptions of optical flow and steady motion. It is applied only for truly bi-directional predicted blocks, which is predicted from two reference frames corresponding to the previous frame and the latter frame. In VCEG-AZ05, BIO utilizes a 5×5 window to derive the motion refinement of each sample. Therefore, for an N×N block, the motion compensated results and corresponding gradient information of an (N+4)×(N+4) block are required to derive the sample-based motion refinement for the N×N block. According to VCEG-AZ05, a 6-Tap gradient filter and a 6-Tap interpolation filter are used to generate the gradient information for BIO. Therefore, the computation complexity of BIO is much higher than that of traditional bi-directional prediction. In order to further improve the performance of BIO, the following methods are proposed.

In a conventional bi-prediction (bi prediction) in HEVC, the predictor is generated using equation (1), where P⁽⁰⁾ and P⁽¹⁾ are the list0 and list1 predictor, respectively.

P_{Conventional}[i, j]= [symbol] P⁽⁰⁾[i, j]+P⁽¹⁾[i, j]+1 [symbol] >>1. (1)

In JCTVC-C204 and VECG-AZ05, the BIO predictor is generated using equation (2).

P_{OpticalFlow}=(P⁽⁰⁾[i, j]+P⁽¹⁾[i, j]+vₓ[i, j](Iₓ⁽⁰⁾−Iₓ⁽¹⁾[i, j])+v_{y}[i, j](I_{y}⁽⁰⁾−I_{y}⁽¹⁾[i, j])+1)>>1. (2)

In equation (2), Iₓ⁽⁰⁾ and Iₓ⁽¹⁾ represent the x-directional gradient in list0 and list1 predictor, respectively; I_{y}⁽⁰⁾ and I_{y}⁽¹⁾ represents the y-directional gradient in list0 and list1 predictor, respectively; vₓ and v_{y} represents the offsets in x- and y-direction, respectively. The above equations are derived using differential techniques to compute velocity from spatiotemporal derivatives of image intensity as shown in eq. (3a) and eq. (3b), where I(x, y, t) represents image intensity in the spatiotemporal coordinates:

$$\begin{matrix}I ( x , y , t ) = I ( x + MV {0}_{x} + {v}_{x} , y + MV {0}_{y} + {v}_{y} , t - Δ t & \\ = I ( x + MV {1}_{x} - {v}_{x} , y + MV {1}_{y} - {v}_{y} , t + Δ t ) . & ( 3 b )\end{matrix} \qquad ( 3 a )$$

Eq. (3a) can be further derived as follows:

$$I ( x + MV {0}_{x} + {v}_{x} , y + MV {0}_{y} + {v}_{y} , t - Δ t ) = {P}^{0} ( x , y ) + {v}_{x} \frac{\partial {P}^{0} ( x , y )}{\partial x} + {v}_{y} \frac{\partial {P}^{0} ( x , y )}{\partial y} \qquad ( 4 a )$$

Similarly, eq. (3b) can be further derived as follows:

$$I ( x + MV {1}_{x} + {v}_{x} , y + MV {1}_{y} - {v}_{y} , t + Δ t ) = {P}^{1} ( x , y ) - {v}_{x} \frac{\partial {P}^{1} ( x , y )}{\partial x} - {v}_{y} \frac{\partial {P}^{1} ( x , y )}{\partial y} . \qquad ( 4 b )$$

Accordingly, the bi-directional optical flow is derived as follows, which is equivalent to eq. (2) with Iₓ⁽⁰⁾=∂P⁰(x, y)/∂x, Iₓ⁽¹⁾=∂P¹(x, y)/∂x, I_{y}⁽⁰⁾=∂P⁰(x, y)/∂y and I_{y}⁽¹⁾=∂P¹(x, y)/∂y:

$${P}_{OpticalFlow} = ( {P}^{0} ( x , y ) + {P}^{1} ( x , y ) + {v}_{x} ( \frac{\partial {P}^{0} ( x , y )}{\partial x} - \frac{\partial {P}^{1} ( x , y )}{\partial x} ) + {v}_{y} ( \frac{\partial {P}^{0} ( x , y )}{\partial y} - \frac{\partial {P}^{1} ( x , y )}{\partial x} ) + 1 ) ≫ 1. \qquad ( 5 )$$

The difference Δ[i, j] between values in two points can be derived according to:

Δ[i, j]=P⁽⁰⁾[i, j]−P⁽¹⁾[i, j]+vₓ[i, j](Iₓ⁽⁰⁾[i, j]+Iₓ⁽¹⁾[i, j])+v_{y}[i, j](I_{y}⁽⁰⁾[i, j]+I_{y}⁽¹⁾[i, j])=P⁽⁰⁾[i, j]+vₓ[i, j]Iₓ⁽⁰⁾[i, j]+v_{y}[i, j]I_{y}⁽⁰⁾[i, j]−(P⁽¹⁾[i, j]−vₓ[i, j]Iₓ⁽¹⁾[i, j]−v_{y}[i, j]I_{y}⁽¹⁾[i, j]). (6)

The difference Δ[i, j] between values in two points is referred as flow difference at two points in this disclosure. In eq. (6), vₓ[i,j] and v_{y}[i,j] are pixel-wise motion vector refinement components, where only fine motion is considered and the major motion is compensated by MC. Also (Iₓ⁽⁰⁾[i, j],I_{y}⁽⁰⁾[i, j]) and (Iₓ⁽¹⁾[i, j],I_{y}⁽¹⁾[i, j]) are gradients of luminance I in the position [i,j] of list0 and list1 reference frames correspondently. The motion vector refinement components, vₓ[i,j] and v_{y}[i,j] are also referred as the x-offset value and the y-offset value in this disclosure.

In order to solve vₓ[i,j] and v_{y}[i,j], a window consisting the pixel being processed and (2M+1)×(2M+1) neighbours is used. The pixel set Ω represents pixels in the window, i.e., [i′, j′]∈Ω if and only if i−M≤i′≤i+M and j−M≤j′≤j+M. The vₓ[i,j] and v_{y}[i,j] are selected based on the values that minimizes:

$${\sum }_{[ {i}^{′} , j ] ∈ Ω} {Δ}^{2} [ {i}^{′} , j ] .$$

The gradient calculation for integer pixel resolution is shown as follows:

Iₓ^{(k)}[i, j]=(P^{(k)}[i+1, j]−P^{(k)}[i, j])/2, (7a)

I_{y}^{(k)}[i, j]=(P^{(k)}[i, j+1]−P^{(k)}[i, j])/2. (7b)

For fractional pixel resolution, interpolation will be performed first and the gradient is calculated as follows:

$$\begin{matrix}\begin{matrix}\begin{matrix}{P}^{( k )} [ i ] = {\sum }_{n = - M + 1}^{M} {F}_{n} ( {α}_{x}^{( k )} ) {R}^{( k )} [ i + n ] , \\ {I}_{x}^{( k )} [ i ] = {\sum }_{n = - M + 1}^{M} {dF}_{n} ( {α}_{x}^{( k )} ) {R}^{( k )} [ i + n ] , k = 0 , 1\end{matrix} \\ {dF}_{n} ( {α}_{x}^{( k )} ) = ( {F}_{n} ( {α}_{x}^{( k )} + h ) - {F}_{n} ( {α}_{x}^{( k )} - h ) ) / 2 h\end{matrix} \\ {I}_{y}^{( k )} [ i , j ] = {\sum }_{n = - M + 1}^{M} {dF}_{n} ( {α}_{y}^{( k )} ) {R}^{( k )} [ i , j + n ] , k = 0 , 1.\end{matrix}$$

In the above equations, α is block motion vector, R^{(k)}[i,j] is reference picture value in integer position [i,j] for references k=0 or 1, Fₙ(α) is filter directly providing derivatives.

For x-directional gradient, if the y-location is an integer, the luma gradient filter is applied. If the y-location is fractional, interpolation in the y direction is performed and luma gradient filter is applied in the x direction. For y-directional gradient, if the x-location is an integer, the luma gradient filter is applied. If the x-location is fractional, luma gradient filter is applied in the y direction and interpolation in the x direction is performed.

In the existing BIO implementation, the window size for vₓ[i,j] and v_{y}[i,j] are 5×5 and BIO is only applied to the luma component with truly bi-predicted 2N×2N coding units (CUs) only. For gradient calculation at fractional pixel resolution, an additional 6-tap interpolation/gradient filter is used. Furthermore, the vertical process is performed first followed by the horizontal process.

### SUMMARY

A method and apparatus of motion compensation using the bi-directional optical flow (BIO) techniques are disclosed. According to one method of the present invention, the use of BIO is extended to general bi-prediction motion compensation by including the case that two reference pictures correspond to two previously coded pictures. In one embodiment, the two x-offset values and two y-offset values for two corresponding positions in two reference blocks have same values, but opposite sign. In another embodiment, the two x-offset values and two y-offset values for two corresponding positions in two reference blocks have same values as well as the sign. In yet another embodiment, the two x-offset values and two y-offset values for two corresponding positions in two reference blocks are proportional to two relative temporal distances between the first reference picture and the current picture and between the second reference picture and the current picture.

According to another method of the present invention, the use of BIO is adaptively applied depending on the linearity of the two motion vectors associated with the two reference blocks or depending on block size of the current block. For example, the current block is encoded or decoded using the bi-directional optical-flow prediction if the linearity of the first motion vector and the second motion vector satisfies a linearity threshold or if the block size of the current block is larger than a threshold block size.

According to yet another method of the present invention, the refined motion vectors by compensating the original motion vectors with the respective x-offset values and y-offset values are stored in a motion-vector buffer for motion vector prediction of one or more following blocks. If the bi-directional optical-flow prediction is applied to the current block on block-level basis for sub-blocks of the current block, the refined motion vectors associated with the sub-blocks are stored in the motion-vector buffer.

### BRIEF DESCRIPTION OF DRAWINGS

FIG. 1 illustrates an example of motion compensation using bi-directional optical flow technique.

FIG. 2 illustrates an exemplary flowchart of a video coding system incorporating an embodiment of the present invention, where the use of BIO is extended to general bi-prediction motion compensation by including the case that two reference pictures correspond to two previously coded pictures.

FIG. 3 illustrates an exemplary flowchart of a video coding system incorporating another embodiment of the present invention, where the use of BIO is adaptively applied depending on the linearity of the two motion vectors associated with the two reference blocks or depending on block size of the current block.

FIG. 4 illustrates an exemplary flowchart of a video coding system incorporating another embodiment of the present invention, where the refined motion vectors by compensating the original motion vectors with the respective x-offset values and y-offset values are stored in a motion-vector buffer for motion vector prediction of one or more following blocks.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

In VCEG-AZ05, the Bi-directional Optical flow (BIO) is implemented as an additional process to the process as specified in the HEVC reference software. The motion compensated prediction according to the conventional HEVC is generated as shown in eq. (1). On the other hand, the motion compensated prediction according to BIO is shown in eq. (2), where additional parameters are determined to modify the conventional motion compensated prediction. The BIO is always applied to those blocks that are predicted with true bi-directions. In order to avoid increasing the memory bandwidth in the worst case, a method of the present invention only applies BIO to larger blocks. For example, an 8-tap interpolation filter for the luma component and a 4-tap interpolation filter for the chroma component are used to perform fractional motion compensation in HEVC. In the case of using a 5×5 window for each to-be-processed pixel as specified in BIO, the worst-case bandwidth is increased from 3.52 (i.e., (8+7)×(8+7)/(8×8)) to 5.64 (i.e., (8+7+4)×(8+7+4)/(8×8)) samples accessed per to-be-processed sample per reference frame. If only blocks with size larger than 8×8 are allowed for the BIO process, the worst case memory requirement for each pixel in BIO is reduced from 5.64 to 2.84 (i.e., (16+7+4)×(16+7+4)/(16×16)), which is even smaller than the original worst-case bandwidth (i.e., 3.52 samples accessed per to-be-processed sample per reference frame). Therefore, the worst-case memory bandwidth will not be increased by restricting the BIO process to block sizes larger than a threshold block size (e.g. 8×8) according to the present invention.

A method is disclosed to reduce the complexity and/or cost associated with the BIO process. According to this method, the gradient filter and the interpolation filter in BIO are unified with the interpolation filter for fractional motion compensation. Currently, the gradient filter and the interpolation filter in BIO are additional processes to the conventional HEVC. These filters are different from the interpolation filter used for motion compensation. The BIO related filters cause additional cost to the BIO process. However, the purpose of the interpolation filter in BIO and the purpose of the interpolation filter in motion compensation are similar since both are intended for approximating the fractional-pel motion. Furthermore, these filters will derive the related information such as interpolated pixel values and gradient values. The gradient filter in BIO can be derived directly from the interpolation filter in BIO. The method will further unify the interpolation filter in BIO with the interpolation filter in fractional-pel motion compensation, and derives the gradient filter from the interpolation filter.

According to the method of unifying interpolation filters as disclosed above, there is no need for an additional interpolation filter. Therefore, the computation becomes unified and simplified. An 8-tap interpolation filter or 4-tap interpolation filer can be used instead of 6-tap interpolation filter as specified in BIO. When 8-tap interpolation filter is used, the gradient filter is also changed and derived directly from the difference between filter coefficients with different fractional positions. For example, for the fractional position equal to ½-pel, the gradient filter coefficients can be derived from the differences between the interpolation filter coefficients for the fractional position equal to ¾-pel and the interpolation filter coefficients for the fractional position equal to ¼-pel divided by 2×(¼). The coding performance of BIO is improved because of the same interpolation filter is used for BIO and motion compensation. However, the computational complexity is increased also. If a 4-tap interpolation filter is used, no additional filter is required and the computation complexity can be further reduced.

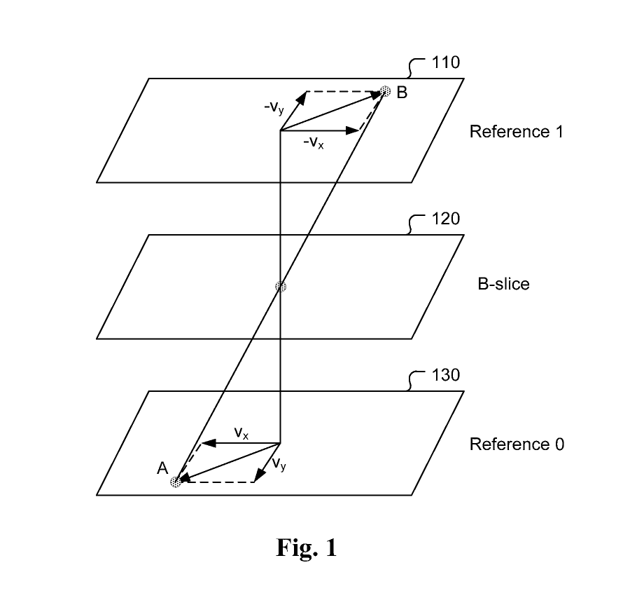

Another method to improve the performance of BIO is to apply BIO for all bi-directional predicted blocks regardless of whether the blocks are “true bi-prediction” or not. According to the assumption of optical flow and steady motion, the corresponding equations and solutions for bi-directional predicted blocks can be used, where both reference frames are previously coded frames by using a similar approach. For example, the x-offset values and the y-offset values for the two corresponding positions (i.e., position A and B in FIG. 1) have the same value, but opposite sign. Accordingly, the x-offset values and the y-offset values for two corresponding positions in two reference blocks of two previously coded frames may have the same value, but opposite sign. In the assumption of steady motion, the temporal distances between current block and two references blocks can be taken into account in the equations. For example, POC (picture order count) is often used for temporal distance. If the temporal distances between current block and two references blocks are m and n, the x-offset values and the y-offset values for two corresponding positions in two reference blocks of two previously coded frames can be proportional to m and n, where m and n are integers. In another embodiment, only the temporal direction should be considered in the corresponding equation for simplicity. In this case, the x-offset values and the y-offset values for two corresponding positions in two reference blocks of two previously coded frames may have the same value and the same sign.

In VCEG-AZ05 the BIO is applied in pixel-level basis. In an embodiment of the present invention, the process of the BIO is applied in the block-level basis. The block size can be N×M, where N and M are integers. All the pixels in an N×M block can share the same motion refinement. If N and M are equal to or greater than 4, the refined motion vector can be stored back to the MV buffers.

The BIO can be applied to sub-PUs (prediction units). For example, if a PU block is allowed for sub-PU partition and each sub-PU can have different motion information or modes, the BIO can be applied to each sub-PU. The initial MV for BIO can be different for each sub-PU.

In yet another embodiment, the BIO and the methods disclosed above can also be extended to the blocks (pixels) of multiple-hypothesis prediction such as Inter-prediction with more than two reference blocks (pixels).

In still yet another embodiment, the BIO operations can be adaptively applied according to the gradient calculations on P⁽⁰⁾ and P⁽¹⁾ or the hybrid predictor (P⁽⁰⁾+P⁽¹⁾).

For example, when the difference between the list0 gradient and list1 gradient is larger than a predefined threshold, the BIO is not applied.

In still yet another embodiment, the BIO operations can be adaptively applied according to the linearity of motion vectors that generates P⁽⁰⁾ and P⁽¹⁾. In other words, if the motion vectors that generates P⁽⁰⁾ and P⁽¹⁾ do not follow linear motion assumption, the refined pixel motions, vₓ and v_{y}, are not reliable. Therefore, the decoder can check the linearity to adaptively apply BIO according to an embodiment of the present invention. For example, the BIO operations can be applied only if the linearity of motion vectors meets a required condition. For example, the current block can be encoded or decoded using the bi-directional optical-flow prediction only if the linearity of the first motion vector and the second motion vector satisfies a linearity threshold.

In still yet another embodiment, if the motion vectors that generate P⁽⁰⁾ and P⁽¹⁾ do not follow linear motion assumption, the decoder can calculate BIO according to the direction of the motion vectors that generates P⁽⁰⁾ and P⁽¹⁾. For example, the decoder can derive pixel motion vectors in proportion to the motion vectors that generate P⁽⁰⁾ and P⁽¹⁾.

In still yet another embodiment, the offsets calculated in the BIO process can be viewed as an offset to refine the motion vectors for all pixels in current block. The refined MVs can be stored in the MV buffer and used for the MV prediction of the following blocks. Note that, if the BIO is performed in a block level (e.g. 4×4 block), the refined MVs are also stored in the block level.

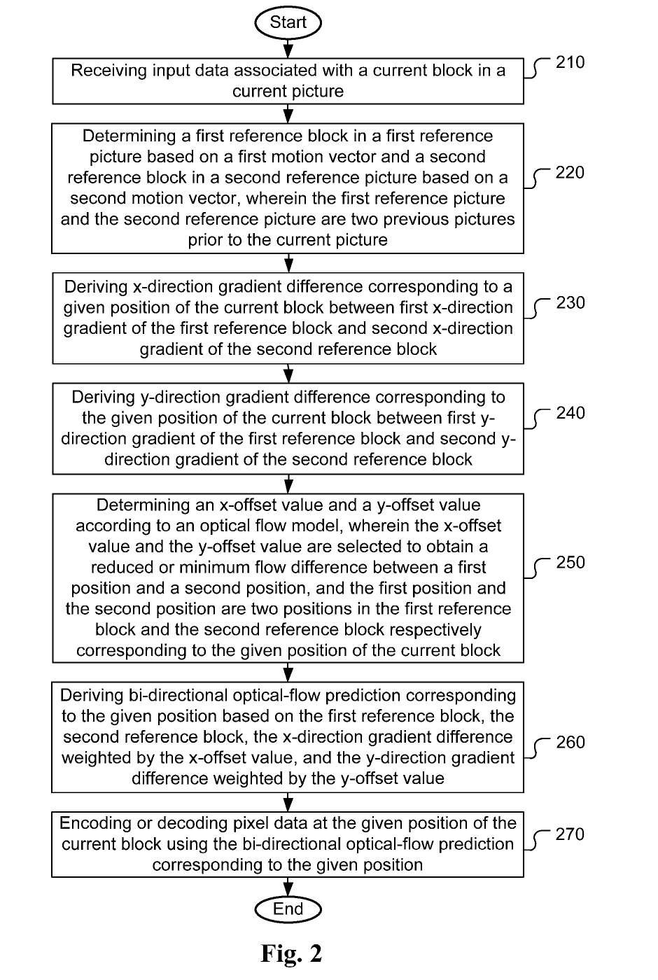

FIG. 2 illustrates an exemplary flowchart of a video coding system incorporating an embodiment of the present invention, where the use of BIO is extended to general bi-prediction motion compensation by including the case that two reference pictures correspond to two previously coded pictures. According to this method, input data associated with a current block in a current picture is received in step 210. A first reference block in a first reference picture based on a first motion vector and a second reference block in a second reference picture based on a second motion vector are determined in step 220, where the first reference picture and the second reference picture are two previously coded pictures. The x-direction gradient difference corresponding to a given position of the current block between first x-direction gradient of the first reference block and second x-direction gradient of the second reference block is determined in step 230. The y-direction gradient difference corresponding to the given position of the current block between first y-direction gradient of the first reference block and second y-direction gradient of the second reference block is determined in step 240. An x-offset value and a y-offset value are determined according to an optical flow model in step 250, where the x-offset value and the y-offset value are selected to obtain a reduced or minimum flow difference between a first position and a second position, and the first position and the second position are two positions in the first reference block and the second reference block respectively corresponding to the given position of the current block. Bi-directional optical-flow prediction corresponding to the given position is derived based on the first reference block, the second reference block, the x-direction gradient difference weighted by the x-offset value, and the y-direction gradient difference weighted by the y-offset value as shown in step 260. Pixel data at the given position of the current block is encoded or decoded using the bi-directional optical-flow prediction corresponding to the given position as shown in step 270.

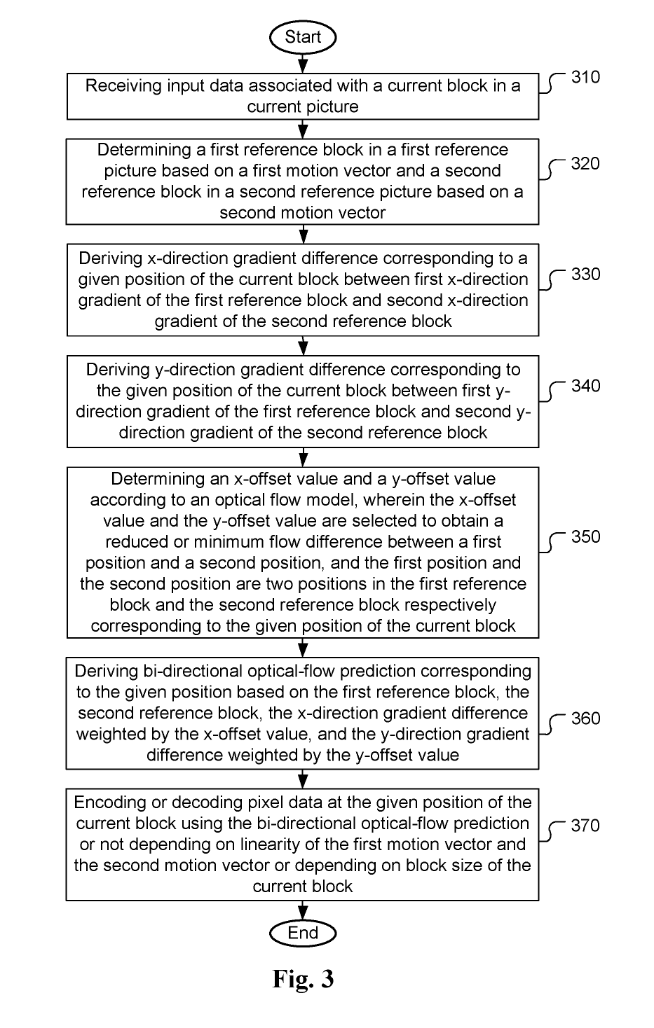

FIG. 3 illustrates an exemplary flowchart of a video coding system incorporating another embodiment of the present invention, where the use of BIO is adaptively applied depending on the linearity of the two motion vectors associated with the two reference blocks or depending on block size of the current block. According to this method, input data associated with a current block in a current picture is received in step 310. A first reference block in a first reference picture based on a first motion vector and a second reference block in a second reference picture based on a second motion vector are determined in step 320. The x-direction gradient difference corresponding to a given position of the current block between first x-direction gradient of the first reference block and second x-direction gradient of the second reference block is determined in step 330. The y-direction gradient difference corresponding to the given position of the current block between first y-direction gradient of the first reference block and second y-direction gradient of the second reference block is determined in step 340. An x-offset value and a y-offset value are determined according to an optical flow model in step 350, where the x-offset value and the y-offset value are selected to obtain a reduced or minimum flow difference between a first position and a second position, and the first position and the second position are two positions in the first reference block and the second reference block respectively corresponding to the given position of the current block. Bi-directional optical-flow prediction corresponding to the given position is derived based on the first reference block, the second reference block, the x-direction gradient difference weighted by the x-offset value, and the y-direction gradient difference weighted by the y-offset value as shown in step 360. Pixel data at the given position of the current block is encoded or decoded using the bi-directional optical-flow prediction or not depending on linearity of the first motion vector and the second motion vector or depending on block size of the current block as shown in step 370.

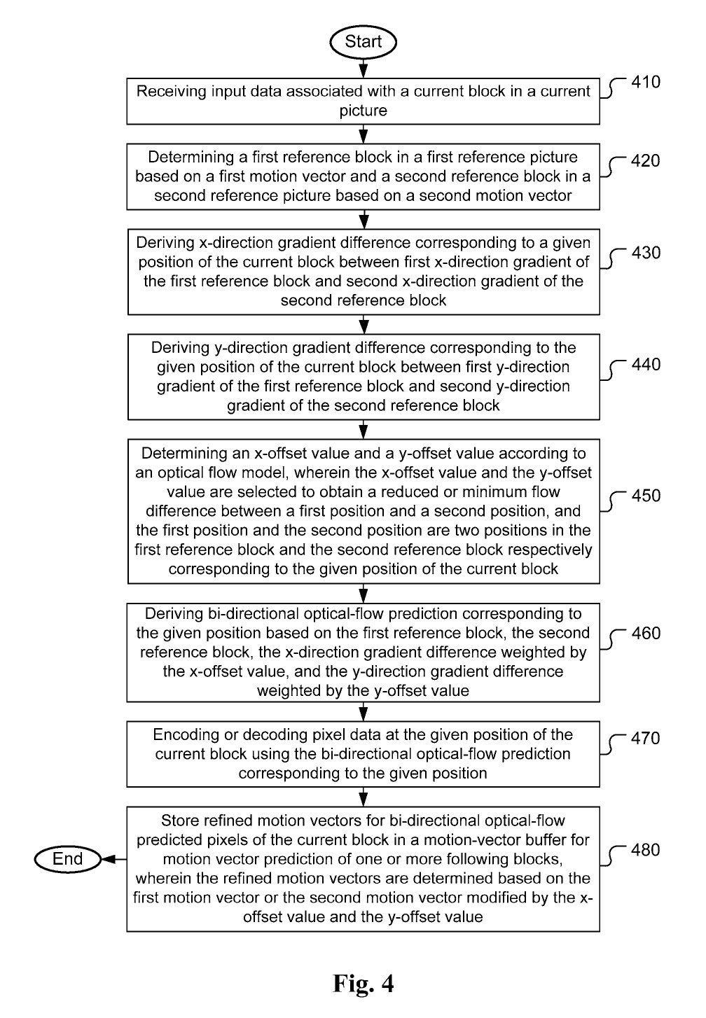

FIG. 4 illustrates an exemplary flowchart of a video coding system incorporating another embodiment of the present invention, where the refined motion vectors by compensating the original motion vectors with the respective x-offset values and y-offset values are stored in a motion-vector buffer for motion vector prediction of one or more following blocks. According to this method, input data associated with a current block in a current picture is received in step 410. A first reference block in a first reference picture based on a first motion vector and a second reference block in a second reference picture based on a second motion vector are determined in step 420. The x-direction gradient difference corresponding to a given position of the current block between first x-direction gradient of the first reference block and second x-direction gradient of the second reference block is determined in step 430. The y-direction gradient difference corresponding to the given position of the current block between first y-direction gradient of the first reference block and second y-direction gradient of the second reference block is determined in step 440. An x-offset value and a y-offset value are determined according to an optical flow model in step 450, where the x-offset value and the y-offset value are selected to obtain a reduced or minimum flow difference between a first position and a second position, and the first position and the second position are two positions in the first reference block and the second reference block respectively corresponding to the given position of the current block. Bi-directional optical-flow prediction corresponding to the given position is derived based on the first reference block, the second reference block, the x-direction gradient difference weighted by the x-offset value, and the y-direction gradient difference weighted by the y-offset value as shown in step 460. Pixel data at the given position of the current block is encoded or decoded using the bi-directional optical-flow prediction corresponding to the given position as shown in step 470. The refined motion vectors for bi-directional optical-flow predicted pixels of the current block are stored in a motion-vector buffer for motion vector prediction of one or more following blocks in step 480, where the refined motion vectors are determined based on the first motion vector or the second motion vector modified by the x-offset value and the y-offset value.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of motion compensation for video data, the method comprising:
receiving input data associated with a current block in a current picture;
determining a first reference block in a first reference picture based on a first motion vector and a second reference block in a second reference picture based on a second motion vector, wherein the first reference picture and the second reference picture are two previously coded pictures;
deriving x-direction gradient difference corresponding to a given position of the current block between first x-direction gradient of the first reference block and second x-direction gradient of the second reference block;
deriving y-direction gradient difference corresponding to the given position of the current block between first y-direction gradient of the first reference block and second y-direction gradient of the second reference block;
determining an x-offset value and a y-offset value according to an optical flow model, wherein the x-offset value and the y-offset value are selected to obtain a reduced or minimum flow difference between a first position and a second position, and the first position and the second position are two positions in the first reference block and the second reference block respectively corresponding to the given position of the current block;
deriving bi-directional optical-flow prediction corresponding to the given position based on the first reference block, the second reference block, the x-direction gradient difference weighted by the x-offset value, and the y-direction gradient difference weighted by the y-offset value; and
encoding or decoding pixel data at the given position of the current block using the bi-directional optical-flow prediction corresponding to the given position.

2. The method of claim 1, wherein two x-offset values for the first position and the second position have a same x-offset value with an opposite sign and two y-offset values for the first position and the second position have a same y-offset value with the opposite sign.

3. The method of claim 1, wherein two x-offset values for the first position and the second position have a same x-offset value with a same sign and two y-offset values for the first position and the second position have a same y-offset value with the same sign.

4. The method of claim 1, wherein two x-offset values for the first position and the second position are proportional to two relative temporal distances between the first reference picture and the current picture and between the second reference picture and the current picture and two y-offset values for the first position and the second position are proportional to the two relative temporal distances between the first reference picture and the current picture and between the second reference picture and the current picture.

5. An apparatus for motion compensation of video data performed by a video coding system, the apparatus comprising one or more electronic circuits or processors configured to:
receive input data associated with a current block in a current picture;
determine a first reference block in a first reference picture based on a first motion vector and a second reference block in a second reference picture based on a second motion vector, wherein the first reference picture and the second reference picture are two previously coded pictures;
derive x-direction gradient difference corresponding to a given position of the current block between first x-direction gradient of the first reference block and second x-direction gradient of the second reference block;
derive y-direction gradient difference corresponding to the given position of the current block between first y-direction gradient of the first reference block and second y-direction gradient of the second reference block;
determine an x-offset value and a y-offset value according to an optical flow model, wherein the x-offset value and the y-offset value are selected to obtain a reduced or minimum flow difference between a first position and a second position, and the first position and the second position are two positions in the first reference block and the second reference block respectively corresponding to the given position of the current block;
derive bi-directional optical-flow prediction corresponding to the given position based on the first reference block, the second reference block, the x-direction gradient difference weighted by the x-offset value, and the y-direction gradient difference weighted by the y-offset value; and
encode or decode pixel data at the given position of the current block using the bi-directional optical-flow prediction corresponding to the given position.

6. The apparatus of claim 5, wherein two x-offset values for the first position and the second position have a same x-offset value with an opposite sign and two y-offset values for the first position and the second position have a same y-offset value with the opposite sign.

7. The apparatus of claim 5, wherein two x-offset values for the first position and the second position have a same x-offset value with a same sign and two y-offset values for the first position and the second position have a same y-offset value with the same sign.

8. The apparatus of claim 5, wherein two x-offset values for the first position and the second position are proportional to two relative temporal distances between the first reference picture and the current picture and between the second reference picture and the current picture and two y-offset values for the first position and the second position are proportional to the two relative temporal distances between the first reference picture and the current picture and between the second reference picture and the current picture.

9. A method of motion compensation for video data, the method comprising:
receiving input data associated with a current block in a current picture;
determining a first reference block in a first reference picture based on a first motion vector and a second reference block in a second reference picture based on a second motion vector;
deriving x-direction gradient difference corresponding to a given position of the current block between first x-direction gradient of the first reference block and second x-direction gradient of the second reference block;
deriving y-direction gradient difference corresponding to the given position of the current block between first y-direction gradient of the first reference block and second y-direction gradient of the second reference block;
determining an x-offset value and a y-offset value according to an optical flow model, wherein the x-offset value and the y-offset value are selected to obtain a reduced or minimum flow difference between a first position and a second position, and the first position and the second position are two positions in the first reference block and the second reference block respectively corresponding to the given position of the current block;
deriving bi-directional optical-flow prediction corresponding to the given position based on the first reference block, the second reference block, the x-direction gradient difference weighted by the x-offset value, and the y-direction gradient difference weighted by the y-offset value; and
encoding or decoding pixel data at the given position of the current block using the bi-directional optical-flow prediction or not depending on linearity of the first motion vector and the second motion vector or depending on block size of the current block.

10. The method of claim 9, wherein the current block is encoded or decoded using the bi-directional optical-flow prediction if the linearity of the first motion vector and the second motion vector satisfies a linearity threshold.

11. The method of claim 9, wherein the current block is encoded or decoded using the bi-directional optical-flow prediction if the block size of the current block is larger than a threshold block size.

12. The method of claim 11, wherein the threshold block size is 8×8.

13. An apparatus for motion compensation of video data performed by a video coding system, the apparatus comprising one or more electronic circuits or processors configured to:
receive input data associated with a current block in a current picture;
determine a first reference block in a first reference picture based on a first motion vector and a second reference block in a second reference picture based on a second motion vector;
derive x-direction gradient difference corresponding to a given position of the current block between first x-direction gradient of the first reference block and second x-direction gradient of the second reference block;
derive y-direction gradient difference corresponding to the given position of the current block between first y-direction gradient of the first reference block and second y-direction gradient of the second reference block;
determine an x-offset value and a y-offset value according to an optical flow model, wherein the x-offset value and the y-offset value are selected to obtain a reduced or minimum flow difference between a first position and a second position, and the first position and the second position are two positions in the first reference block and the second reference block respectively corresponding to the given position of the current block;
derive bi-directional optical-flow prediction corresponding to the given position based on the first reference block, the second reference block, the x-direction gradient difference weighted by the x-offset value, and the y-direction gradient difference weighted by the y-offset value; and
encode or decode pixel data at the given position of the current block using the bi-directional optical-flow prediction or not depending on linearity of the first motion vector and the second motion vector or depending on block size of the current block.

14. The apparatus of claim 13, wherein the current block is encoded or decoded using the bi-directional optical-flow prediction if the linearity of the first motion vector and the second motion vector satisfies a linearity threshold.

15. The apparatus of claim 13, wherein the current block is encoded or decoded using the bi-directional optical-flow prediction if the block size of the current block is larger than a threshold block size.

16. The apparatus of claim 15, wherein the threshold block size is 8×8.

17. A method of motion compensation for video data, the method comprising:
receiving input data associated with a current block in a current picture;
determining a first reference block in a first reference picture based on a first motion vector and a second reference block in a second reference picture based on a second motion vector;
deriving x-direction gradient difference corresponding to a given position of the current block between first x-direction gradient of the first reference block and second x-direction gradient of the second reference block;
deriving y-direction gradient difference corresponding to the given position of the current block between first y-direction gradient of the first reference block and second y-direction gradient of the second reference block;
determining an x-offset value and a y-offset value according to an optical flow model, wherein the x-offset value and the y-offset value are selected to obtain a reduced or minimum flow difference between a first position and a second position, and the first position and the second position are two positions in the first reference block and the second reference block respectively corresponding to the given position of the current block;
deriving bi-directional optical-flow prediction corresponding to the given position based on the first reference block, the second reference block, the x-direction gradient difference weighted by the x-offset value, and the y-direction gradient difference weighted by the y-offset value;
encoding or decoding pixel data at the given position of the current block using the bi-directional optical-flow prediction corresponding to the given position; and
storing refined motion vectors for bi-directional optical-flow predicted pixels of the current block in a motion-vector buffer for motion vector prediction of one or more following blocks, wherein the refined motion vectors are determined based on the first motion vector or the second motion vector modified by the x-offset value and the y-offset value.

18. The method of claim 17, wherein if the bi-directional optical-flow prediction is applied to the current block on block-level basis for sub-blocks of the current block, the refined motion vectors associated with the sub-blocks are stored in the motion-vector buffer.

19. An apparatus for motion compensation of video data performed by a video coding system, the apparatus comprising one or more electronic circuits or processors configured to:
receive input data associated with a current block in a current picture;
determine a first reference block in a first reference picture based on a first motion vector and a second reference block in a second reference picture based on a second motion vector;
derive x-direction gradient difference corresponding to a given position of the current block between first x-direction gradient of the first reference block and second x-direction gradient of the second reference block;
derive y-direction gradient difference corresponding to the given position of the current block between first y-direction gradient of the first reference block and second y-direction gradient of the second reference block;
determine an x-offset value and a y-offset value according to an optical flow model, wherein the x-offset value and the y-offset value are selected to obtain a reduced or minimum flow difference between a first position and a second position, and the first position and the second position are two positions in the first reference block and the second reference block respectively corresponding to the given position of the current block;
derive bi-directional optical-flow prediction corresponding to the given position based on the first reference block, the second reference block, the x-direction gradient difference weighted by the x-offset value, and the y-direction gradient difference weighted by the y-offset value;
encode or decode pixel data at the given position of the current block using the bi-directional optical-flow prediction corresponding to the given position; and
store refined motion vectors for bi-directional optical-flow predicted pixels of the current block in a motion-vector buffer for motion vector prediction of one or more following blocks, wherein the refined motion vectors are determined based on the first motion vector or the second motion vector modified by the x-offset value and the y-offset value.

20. The apparatus of claim 19, wherein if the bi-directional optical-flow prediction is applied to the current block on block-level basis for sub-blocks of the current block, the refined motion vectors associated with the sub-blocks are stored in the motion-vector buffer.
